(19) United States
(12) Patent Application Publication
(10) Pub. No.: US 2014/0117120 A1
(43) Pub. Date: May 1, 2014

(54) COATING PACKAGED SHOWERHEAD PERFORMANCE ENHANCEMENT FOR SEMICONDUCTOR APPARATUS

(71) Applicant: Advanced Micro-Fabrication Equipment Inc, Shanghai, Shanghai (CN)

(72) Inventors: Xiaoming HE, Shanghai (CN); Tuqiang Ni, Shanghai (CN); Hanting ZHANG, Shanghai (CN); Zhaoyang XU, Shanghai (CN); Mingfang WANG, Shanghai (CN); Lei WAN, Shanghai (CN); Ping YANG, Shanghai (CN)

(73) Assignee: Advanced Micro-Fabrication Equipment Inc, Shanghai, Shanghai (CN)

(21) Appl. No.: 14/065,130

(22) Filed: Oct. 28, 2013

(30) Foreign Application Priority Data
Oct. 29, 2012 (CN) 201210421403.4

(51) Int. Cl. B05B 1/00

(52) U.S. Cl. CPC B05B 1/005
USPC 239/548; 427/569; 427/576; 427/570; 204/192.1

(57) ABSTRACT

An advanced coating for showerhead used in plasma processing chamber is provided. The advanced coating is formed using plasma enhanced physical vapor deposition. The coating formation involved a physical process, such as condensation of source material on the showerhead surface, and chemical process, wherein active species from plasma interact with the condensed source materials. Also, non-reactive species from the plasma impinge on the bottom surface to condense the formed coating.

This application claims the priority of Chinese Patent Application No. 201210421403.4, entitled “COATING PACKAGED SHOWERHEAD PERFORMANCE ENHANCEMENT FOR SEMICONDUCTOR APPARATUS”, filed with the Chinese Patent Office on Oct. 29, 2012, which is incorporated by reference in its entirety herein.

### BACKGROUND

1. Field

The subject invention relates to plasma processing chambers and, in particular, to a coating for a showerhead of a plasma processing chamber, which enhances the performance of the showerhead in the presence of active plasma species.

2. Related Art

In plasma processing chambers, a showerhead is often used to inject the process gas. In certain plasma chambers, such as capacitively-coupled plasma chambers, the showerhead may also function as an electrode, coupled to either ground or RF potential. However, during processing the showerhead is exposed to the plasma and is attacked by the active species within the plasma, such as halogen plasma of CF₄, Cl₂, etc. This phenomenon is especially troublesome for showerheads having a chemical vapor deposited silicon carbide coating (CVD SiC).

Various coatings have been proposed and tested in the prior art for protecting the showerhead from plasma erosion. Yttria (Y₂O₃) coating is believed to be promising; however, it has been very difficult to find a process that results in good coating, especially one that does not crack or generate particles. For example, there have been proposals to use plasma spray (or PS) to coat a showerhead made of metal, alloy or ceramic. However, conventional PS Y₂O₃ coating is formed by the sprayed Y₂O₃ particles, and generally results in a coating having high surface roughness (Ra of 4 micron or more) and relatively high porosity (volume fraction is above 3%). The high surface roughness and porous structure makes the coating susceptible to generation of particles, which may contaminate the wafer being processed. In addition, the particle will come out from the gas holes and dropped on the wafer when the as-coated shower head is used in the plasma process, as the plasma sprayed coating inside the gas hole is very rough and has poor adhesion to the substrate.

Other proposals for forming Yttria coating involve using chemical vapor deposition (CVD), physical vapor deposition (PVD), ion assisted deposition (IAD), active reactive evaporation (ARE), ionized metal plasma (IMP), sputtering deposition and plasma immersion ion process (PIIP). However, all these deposition processes have some technical limitations such that they have not been actually used to scale up for the deposition of thick coating on the chamber parts for the plasma attack protections. For instance, CVD of Y₂O₃ can not be carried out on substrates that cannot sustain temperatures above 600° C., which excludes the deposition of plasma resistant coating on chamber parts that are made of aluminum alloys. PVD process, such as evaporation, can not deposit dense and thick ceramic coating because of their poor adhesion to substrate. Other deposition processes can not deposit thick coating either due to the high stress and poor adhesion (such as sputtering deposition, ARE and IAD) or the very low deposition rate (such as sputtering deposition, IMP and PIIP). Therefore, so far no satisfactory coating has been produced, that would have good erosion resistance, while generating low or no particles and can be made thick without cracking or delamination.

In view of the above-described problems in the art, a solution is needed for a coating that resists plasma species attack and does not generate particle or cracks. The coating should have acceptable roughness and porosity values, so that it could provide long service life. The process for fabricating the coating should allow thick coating without being susceptible to cracking or delamination.

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

According to an aspect of the invention, methods are provided for the formation of advanced plasma resistant coatings on showerheads. According to various embodiments, the process of the coating the showerhead surface is provided so that the service performance of the coated showerhead is improved. Other embodiments involve the modification and installation of the coated showerhead into the plasma chamber, so as to improve the plasma process quality.

In an exemplary process, an advanced Yttria coating, e.g., Y₂O₃ or YF₃ based coatings, with fine/compact grain structure and random crystal orientation is created by a plasma enhanced physical vapor deposition (PEPVD) process, in which (1) the deposition is carried out in a low pressure or vacuum chamber environment; (2) at least one deposition element or component is evaporated or sputtered out off a material source and the evaporated or sputtered material condenses on the substrate surface (this part of the process is a physical process and is referred to herein as the physical vapor deposition or PVD part); (3) meanwhile, a plasma source (or sources) is (are) used to emit out ions and to generate plasma that surrounds the showerhead surface and at least one deposition element or component is ionized and reacted with the evaporated or sputtered elements or components in plasma or on the surface of the showerhead; and (4) the showerhead is coupled to a negative voltage, such that it is bombarded by the ionized atoms or ions during the deposition process. The actions from (3) and (4) are referred to as the “plasma enhanced (or PE)” function of the PEPVD.

It should be mentioned that the plasma source(s) could be used either (1) to ionize, decompose, and activate the reactive gases so that the deposition process can be performed in a low substrate temperature and with a high coating growth rate as more ions and radicals are generated by plasma, or (2) to generate the energetic ions aimed at the showerhead so that the ion impinges on the surface of the shower head and helps to form the thick and dense coatings thereon. More perfectly, the plasma sources will be used as the alternative or the combinations of functions (1) and (2), to lead the formation of the coating on the shower head. Such a coating synthesized with the enough thickness and the dense structure is generally referred to herein as “advanced coating” (e.g. A-coating), for instance, such as A-Y₂O₃, A-YF₃, or A-Al₂O₃ based coatings.

In order to improve the coating formation, the deposition of A-coating is performed on the rough surface of the substrates or showerhead, to improve the adhesion of the coating to substrate and to increase the deposition thickness. This is because the increase of surface roughness of the material increases the contact area in the interfacial region between the coating and substrate surface, and changes of the coating contact area from more 2-dimensional fraction to more 3-dimensional fraction. The deposition on the rough surface induces the formation of coating with random crystal orientation and results in the release of the interfacial stress between the A-coating and the substrates, which enhances the coating adhesion to the substrate and promotes the formation of thick and dense coating thereon. It has been expected that the improved stability of A-coating on materials surface can be reached if the coating is deposited on materials with the surface roughness at least above 4 um.

In order to reduce the production cost, another embodiment involves the formation of double layered coating combinations in which the first coating is formed on the showerhead base as the anodization, the plasma spray Y₂O₃, or other plasma resistant coatings, with a certain thickness designed to maintain the required electrical properties of the formed showerhead and the first layer has the surface roughness above 4 um. A second coating is formed over the first layer that is at least 4 um in roughness and the second coating thus has a top surface facing to plasma in the plasma processes. The second coating can be formed as the A-coating (e.g. A-Y₂O₃, A-YF₃, etc.), and the formed coatings have the specified roughness (surface roughness Ra≧1.0 um) and dense structure with random crystal orientation and with a porosity less than 3% or without porous defects. Consequently, particle contamination, which is usually induced by plasma spray coating due to the rough surface and porous structure, can be reduced, while A-coating is used as the showerhead exterior surface. In addition, due to the dense crystal structure, the second coating has reduced plasma erosion rate, which could further reduce metal contamination in the plasma processes. The thicknesses of either the first coating or the second coating can be adjusted according to the performance requirement on the showerhead.

In another embodiment, the showerhead surface is coated by double layered coating combinations, in which the first coating is formed on the showerhead base by anodization, by plasma spray, or by other technologies, and with enough thickness to provide the desired process functions of the showerhead in the plasma processes (such as required electrical conductivity, thermal conductivity or thermal barrier function, and other functions). The second coating is formed on the first coating to form a top surface facing the plasma in the plasma etch processes. The first coating could be either plasma resistant or other function coatings with or without uniform distribution in thickness and/or composition on the showerhead base surface. The second coating is the A-coatings, such as A-Y₂O₃ coating. Since the A-coating has the specified roughness (Ra≧1.0 um) and dense structure with random crystal orientation and with a porosity less than 3% or without porous defects, the A-coating has plasma erosion rate much lower than the first coating, which would not create particles and should have reduced metal contamination in the plasma processes. The thicknesses and the roughness of either the first coating or the second coating can be adjusted according to the performance requirement on the showerhead.

In another embodiment, the multi-layered coatings are deposited on the showerhead, such that the coated showerhead has an increased coating thickness, a stable surface facing the plasma chemistry, and the desired functions to improve the process performance of the plasma chamber. As different from the coating that is deposited as a single layered structure, the same material with the multilayered structure can be deposited to reach an increased thickness with a reduced risk of crack formation, as the increased interfacial areas due to the multi-layers can release the coating stress that is usually increased with the increase of the coating thickness. The multilayered coating is composed by either the multilayered A-coatings or the combination of the multi-layered functions coating with the multi-layered A-coatings whose top layer faces the plasma, for instance, when the coatings are deposited on the showerhead. It has been confirmed that the multi-layered A-coating with random crystal orientation can be deposited on the showerhead to thicknesses above 50 um without cracking and delamination if the showerhead has a surface roughness above 4 um.

In another embodiment, in order further to improve the performance of the coating packaged showerhead, surface processes are applied on the as-coated showerhead, which includes, but not limited to, surface smoothening or roughening to reduce the particles, surface modification to enhance the surface density and stability of the coatings, and surface chemical cleaning to remove the particles and contamination that are formed on the coated showerhead either due to the coating deposition process or due to the plasma etching process.

According to one aspect, the surface roughness of the A-coating is controlled, since if the surface is too smooth, polymer deposition during etching will not adhere well to the surface, and thus induce particles. On the other hand, too rough surface will directly create particles due to the plasma etching. The recommended surface roughness is at least 1 um or above for the A-coatings, which can be reached by the adjustment of the substrate roughness, by the deposition process, or by lapping, polishing and other post surface treatment on the deposited coatings.

According to another aspect, the energetic ion bombardment or plasma etching in the PEPVD is used to smooth/rough and densify the surface of A-coating coated showerhead. The coated showerhead surface can be cleaned by wet solution cleaning in which the erosive solution or slurry or aerosol is used to blast away the surface particles and to control the surface roughness of the coating either on the flat plate or inside the gas holes. The dense coating with the specified roughness could have the fine and compact grain structure with reduced porous volume defects, and thus reduce the plasma erosion rate and maintain clean environment during the plasma etch processes.

To reach performance improved etch processes, the coated showerhead can be formed with modification or combination of the gas distribution plate, showerhead aluminum base and the upper ground ring into one piece of coated showerhead, or the one piece of showerhead with the build-in heater, so that the formation of the new coated showerhead can reduce the production cost and the coated showerhead is easy to be refurbished once it is used for a certain service cycles. In essence, the various parts of the showerhead can be coated so as to be “packaged” by or inside the A-coating layer.

The base or intermediate coating could be of metals, alloys, or ceramics (such as Y₂O₃, YF₃, ErO₂, SiC, Si₃N₄, ZrO₂, Al₂O₃ and their combinations or combination of them with other elements). The second or the top coating with the surface facing the plasma could be A-coating of Y₂O₃, YF₃, ErO₂, SiC, Al₂O₃ and their combinations or combination of them with other materials. As quite different from the prior art, it is suggested that the A-coating is deposited on the substrate materials that may have the element(s) and/or component(s) which are also contained in the A-coating, such as the deposition of A-Y₂O₃ on anodized surface, Y₂O₃ surface, or Al₂O₃ surface. Since the same elements or components occurred in both the coating and the substrate will result in the formation of the atomic bondings from the same elements or components in the interfacial region between the A-coating and the substrates, which promotes the formation of A-coating with the increased thickness and the improve adhesion to the substrates or showerhead.

Various methods are disclosed for deposition of A-coating with random crystal orientation and thickness of 50 microns or more, without cracks or delamination. In one embodiment, the surface of the part to be coated is roughened to Ra of 4 microns or more prior to the coating. It was shown that the roughness of 4 micron is critical for reduction of cracks and delamination. Additionally, rather than depositing a single-layer coating to the desired thickness, a series of thinner coatings are deposited, that add up to the desired thickness. For example, if a 50 micron coating of A-Y₂O₃ is desired, rather than depositing a single layer, several layers, e.g., five layers of ten microns each are deposited sequentially. Normally, as the thickness of the coating increases, the stress within the coating also increases. However, depositing the coating as a multi-layer structure releases the stress, thus reducing the risk of cracks and delamination.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a schematic of an apparatus for depositing advanced coating in accordance with one embodiment of the invention;

FIG. 2A illustrates a conventional showerhead and electrode assembly for a plasma chamber, while FIG. 2B illustrates a showerhead having generally the same structure as that of FIG. 2A, except that it includes the advance coating according to an embodiment of the invention;

FIG. 2C illustrates another embodiment, wherein the showerhead assembly is “packaged” in the A-coating;

FIG. 2D illustrates another embodiment, wherein the showerhead assembly has one pieces gas distribution plate that is “packaged' in the A-coating.

FIG. 2E illustrates another embodiment, wherein the showerhead assembly with one piece gas distribution plate is “packaged” in the A-coating;

FIG. 2F illustrates another embodiment, wherein the showerhead assembly with one piece gas distribution plate is coated with an intermediate coating and then with the A-coating; and

FIG. 3 illustrates a plasma chamber incorporating a showerhead according to an embodiment of the invention.

### DETAILED DESCRIPTION

Various embodiments will now be described, providing improved coatings for showerheads, which improve erosion and particle performance of the showerhead. The description will begin with the apparatus and method for forming the coating, and then proceeds to examples of showerheads and coatings fabricated using the disclosed method.

Unlike conventional plasma spray, in which the coating is deposited in atmospheric environment, the advanced coating disclosed herein is deposited in low pressure or vacuum environment. Also, while in plasma spray the coating is deposited using small powdery particles, the advanced coating is deposited by the condensation of atoms radicals, or molecules on the materials surfaces. Consequently, the characteristics of the resulting coating layer is different from the prior art coating, even when the same material composition is used. For example, it was found that a Y₂O₃ coating deposited according to embodiment of the invention has practically no porosity, specified surface roughness above 1 um, and has a much higher etch resistance than the conventional PS Y₂O₃ coating.

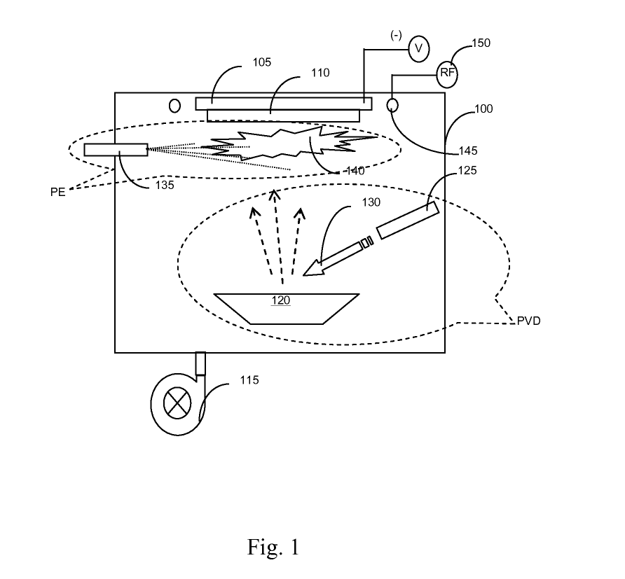

An embodiment of the invention will now be described in detail with reference to the Figures. First, the equipment and method for depositing the advanced coating will be described. FIG. 1 illustrates an apparatus for depositing advanced coating in accordance with one embodiment of the invention. This apparatus is used for depositing the advanced coating using the process referred to herein as PEPVD, wherein the PE and PVD components are highlighted by the broken-line callouts in FIG. 1. Traditionally, chemical vapor deposition (CVD) or plasma enhanced chemical vapor deposition (PECVD) refer to a chemical process wherein a thin film is formed on the substrate's surface by exposing the substrate to one or more volatile precursors, which react and/or decompose on the substrate surface to produce the desired deposited film. PVD, on the other hand, refers to a coating method which involves purely physical processes, wherein thin films are deposited on the surface of the substrate by the condensation of a vaporized or sputtered form of the desired film materials that can be usually the solid source materials. Therefore, one may characterize PEPVD as somewhat of a hybrid of these two processes. That is, the disclosed PEPVD involves both physical process of atom, radicals, or molecular condensation (the PVD part) and plasma induced chemical reaction in the chamber and on the substrate's surface (the PE part).

In FIG. 1, chamber 100 is evacuated by vacuum pump 115. The part 110 to be coated, in this example the showerhead, but it can be any other part to be coated, is attached to a holder 105. Also, a negative bias is applied to the part 110, via holder 105.

A source material 120 containing species to be deposited is provided, generally in a solid form. For example, if the film to be deposited is Y₂O₃ or YF₃ based, source material 120 would include yttrium (or fluorine)-possibly with other materials, such as oxygen, fluorine (or yttrium) etc. To form the physical deposition, the source material is evaporated or sputtered. In the example of FIG. 1, the evaporation is achieved using electron gun 125, directing electron beam 130 onto the source material 120. As the source material is evaporated, atoms and molecules drift towards and condense on the part 110 to be coated, as illustrated by the broken-line arrows.

The plasma enhanced part is composed of a gas injector 135, which injects into chamber 100 reactive and non-reactive source gases, such as argon, oxygen, fluorine containing gas, etc., as illustrated by the dotted lines. Plasma 140 is sustained in front of part 110, using plasma sources, e.g., RF, microwave, etc., one of which in this example is shown by coil 145 coupled to RF source 150. Without being bound by theory, it is believed that several processes take place in the PE part. First, non-reactive ionized gas species, such as argon, impinging the part 110, so as to condense the film as it is being “built up”. The effects of ion impinging may result from the negative bias on showerhead 110 and showerhead holder 105, or from the ions emitted out from the plasma sources and aimed at showerhead 105. Second, reactive gas species or radicals, such as oxygen or fluorine, react with the evaporated or sputtered source material, either inside the chamber or on the surface of the part 110. For example, the source Yttrium reacts with the oxygen gas to result in Y containing coating, such as Y₂O₃ or YF₃. Thus, the resulting process has both a physical (impingement and condensation) component and a chemical component (e.g. oxidation).

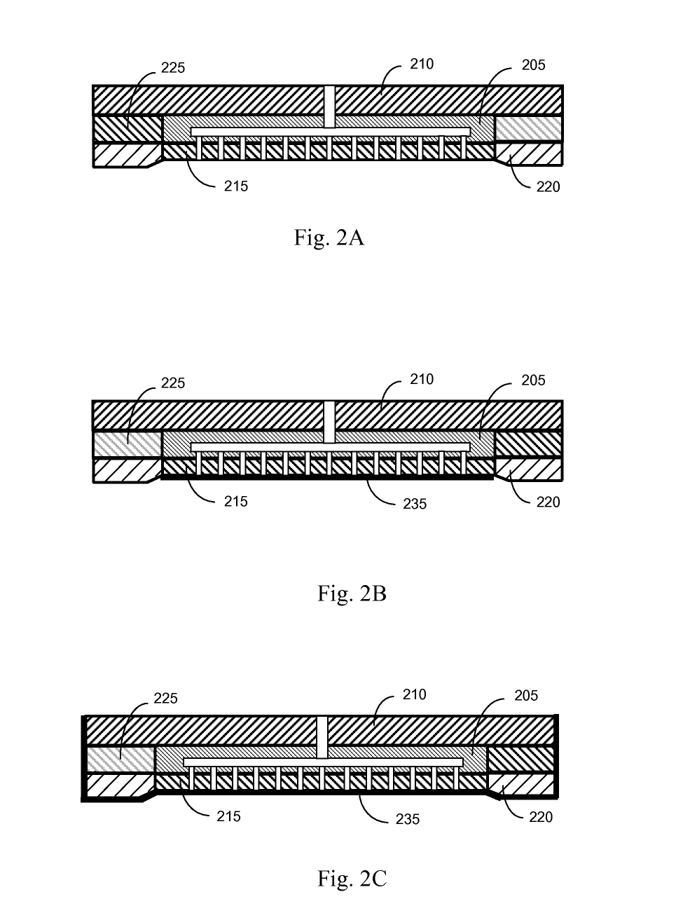

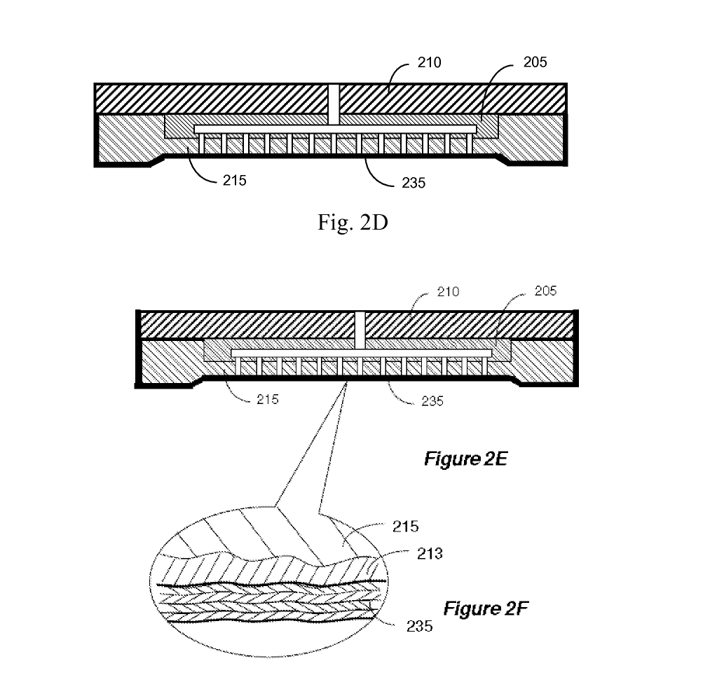

FIG. 2A illustrates a conventional showerhead and electrode assembly for a plasma chamber. Conductive plate 205, sometimes, can be converted as the heater to control the temperature of the showerhead, is sandwiched between back plate 210 and perforated plate 215. Conductive ring 220 surrounds the perforated plate 215 and can work as the assistant electrode. Support ring 225 surrounds conductive plate 205 and is also sandwiched between conductive ring 220 and back plate 210. Perforated gas plate 215, actually working as a gas distribution plate (or GDP), may be made of ceramic, quartz, etc., for example, it may be made of silicon carbide, and may be assembled to the lower surface of conductive plate 205. Conductive ring 220 may be made of ceramic, quartz, etc., for example, it may be made of silicon carbide, and may be assembled to the lower surface of support ring 225. The support ring 225, the conductive plate 205 and the back plate 210 may be made of metal and alloy, e.g., aluminum, stainless steel, etc. The showerhead is affixed to the ceiling of the plasma chamber, in a well-known manner.

FIG. 2B illustrates a showerhead having generally the same structure as that of FIG. 2A, except that it includes the advance coating according to an embodiment of the invention. In FIG. 2B the advanced coating 235 (for example, A-Y₂O₃) is provided on the bottom surface of the perforated plate 215, i.e., the surface that faces the plasma during substrate processing. The advanced coating 235 may be the single layer or the multilayered coatings. In this embodiment, the perforated plate is fabricated according to standard procedures, including formation of gas injection holes/perforations. Then, the plate is inserted into a PEPVD chamber and the bottom surface is coated with advanced coating. Since the PEPVD coating uses atoms or molecules for buildup of the coating, the interior of the gas injection holes is also coated. However, unlike prior art coating, the advance coating is formed by the condensation of atoms and molecules, and results in a dense and uniform A-coating with the good adhesion to the interior surface of the gas holes, thereby providing smooth gas flow and avoiding any particle generation.

While according to above embodiment the surface of the coated perforated plate is characterized with the specified surface roughness (surface roughness is controlled equal to larger than Ra 1.0 um), according to one embodiment the surface is roughened in order to promote polymer adhesion during plasma processing. That is, according to one aspect, the surface roughness of the A-coating is controlled, since if the surface is too smooth, polymer deposition during etching will not adhere well to the surface, and thus induce particles. On the other hand, too rough surface will directly create particles due to the plasma etching. Therefore, according to this embodiment the recommended surface roughness Ra is above 1 um. Perfectly, the recommended surface roughness Ra is above 1 um, but below 10 um (1 um<Ra<10 um). It has been found that in this range the particle generation is minimized, while polymer adhesion is controlled. That is, the noted range is critical because using higher roughness leads to particle generation, while using smoother coating diminishes adhesion of the polymers during plasma processing. In all cases, the A-coating with either single or multilayered structure has the dense structure with random crystal orientation and porosity less than 3% and has no any crack or delamination.

According to one embodiment this roughness is achieved by the as-deposited coating, or by lapping, polishing or other post PEPVD surface treatment on the as-deposited coatings. On the other hand, according to one embodiment the surface of the perforated plate is first roughened to the desired roughness (Ra>4 um), and then the coating is deposited. Since the coating is done using PEPVD, the resulting coating may have the same or different roughness as the surface prior to the coating, according to the thickness of the coating and the deposition process.

FIG. 2C illustrates another embodiment, wherein the showerhead assembly is “packaged” in the A-coating. That is, as shown in FIG. 2C, the lower surface of the entire showerhead assembly is coated with the A-coating 235 (for example A-Y₂O₃). In this example, various parts forming the showerhead are first assembled, and then are positioned inside the PEPVD chamber to form the advanced coating over the lower surface of the entire assembly. In this manner, the showerhead assembly is “packaged” by the advanced coating and is fully protected from plasma erosion. As discussed with reference to FIG. 2B, the surfaces may remain smooth, or may be roughened so as to promote polymer adhesion. In all cases, however, the coating thickness is above 50 um.

FIG. 2D illustrates another embodiment, wherein the perforated plate 215, conductive ring 220 and support ring 225 in former embodiments are united as one piece perforated gas plate (or GDP) 215 in this embodiment. As quite different from the prior art, the one piece perforated gas plate 215 can be made of metals, for instance, Al alloy, and the surface can be protected by the deposition of A-coatings 235, such as A-Y₂O₃. As comparing to the prior art, the formation of showerhead by A-Y₂O₃ coating 235 over the perforated gas plate 215 can reduce the product cost, simplifies the assembly and manufacture procedure of shower head, and increase the work life time. Another advantage is that it provides the possibility to refurbish the used showerhead simply by the re-deposition of A-coating 235 over the one piece perforate gas plate 215. In addition, it is more easy to form the A-coating “packaged” showerhead, as again another embodiment showing in FIG. 2E, since the deposition of A-coating is carried out on the showerhead that formed only by the assembly of the one piece perforated gas plate 215 to the conductive plate 205 and back plate 210.

FIG. 2F illustrates yet another embodiment of the invention. FIG. 2F is drawn as a callout from FIG. 2E to indicate that it depicts an enlarge section of a showerhead similar to that shown in FIG. 2E, except that it has a different coating scheme. In the embodiment of FIG. 2F, the perforated gas plate 215 has an intermediate coating 213. The intermediate layer is formed on the roughened surface of the perforate gas plate 215, and the surface of the intermediate layer where the A-coating is deposited thereon also has a roughened surface. The intermediate layer may be, for example, an anodized layer or a plasma sprayed Y₂O₃ coating. Then an advanced coating 235, according to any of the embodiments described herein, is deposited as a single layer or multi-layered structure over the intermediate coating 213. Moreover, each of the A-coating 235 and the intermediate layer 213 can be formed as the multi-layered coatings, so that the thickness of the coating can be increased and the structure stability of the deposited coatings can be improved.

According to one example, the perforated gas plate is the anodized plate where the surface and inside gas holes are all protected by the anodization, such as the hard anodization. Then, the deposition of A-coatings, such as A-Y₂O₃ is performed either on the surfaces of perforate plate (expect the back side surface contact to the conductive plate 205 and back plate 210) as showing in FIG. 2D or on the surface of the assembled showerhead as showing in FIG. 2E. Since the deposition of A-coating is directly on the anodized surface, there is no interfacial issue between A-coating and anodization, which usually exists between the PS Y₂O₃ coating and the anodized surface as the PS Y₂O₃ is normally deposited on the bare Al alloy, to reach a good adhesion of PS Y₂O₃ coating to the chamber parts.

According to various embodiments, the intermediate coating could be of metals, alloys, or ceramics (such as Y₂O₃, YF₃, ErO₂, SiC, Si₃N₄, ZrO₂, Al₂O₃ and their combinations or combination of them with other elements). The second or the top coating with the surface facing to plasma is the A-coating of Y₂O₃, YF₃, ErO₂, SiC, Al₂O₃ and their combinations or combination of them with other materials.

As quite different from the prior art, according to some embodiments the A-coating is proposed to be deposited on the substrate materials that could have at least one element or component which is also contained in the A-coating, such as the deposition of A-Y₂O₃ on anodized surface, Al₂O₃ or Y₂O₃ surface. Since the same elements or components occurred in both the coating and the substrate will result in the formation of the atomic bondings from the same elements or components in the interfacial region between the A-coating and the substrates, which promotes the formation of A-coating with the increased thickness and the improve adhesion to the substrates or showerhead.

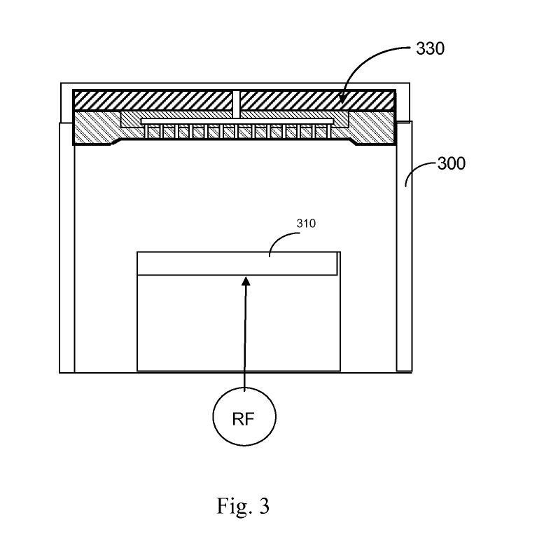

FIG. 3 illustrates a plasma chamber wherein a showerhead according to any of the embodiments disclosed herein is affixed to the ceiling thereof. The chamber body 300 forms a hermetic seal for evacuation of the chamber. The substrate to be processed is placed on the chuck 310, and RF power is applied, in this example to the electrode within the chuck 310. The showerhead 330 is used to inject process gas into the chamber and to functions as an electrode to provide either ground path or RF potential path.

It should be understood that processes and techniques described herein are not inherently related to any particular apparatus and may be implemented by any suitable combination of components. Further, various types of general purpose devices may be used in accordance with the teachings described herein. The present invention has been described in relation to particular examples, which are intended in all respects to be illustrative rather than restrictive. Those skilled in the art will appreciate that many different combinations will be suitable for practicing the present invention.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claim.

What is claimed is:

1. A showerhead for a plasma processing chamber, comprising:
a perforated gas plate having a plurality of gas injection holes, and further having a surface facing and exposed to the plasma during processing; and,
an advanced coating formed on the surface of the perforate gas plate and having a dense structure with random crystal orientation and with a porosity less than 3% and a surface roughness above 1 um.

2. The showerhead of claim 1, wherein the surface of the perforate gas plate, prior to the advanced coating, has a surface roughness above 4 um.

3. The showerhead of claim 1, further comprising an intermediate coating formed over the surface prior to the advanced coating, wherein the intermediate coating has a surface roughness above 4 um.

4. The showerhead of claim 3, wherein the intermediate coating comprises anodized layer.

5. The showerhead of claim 3, wherein the intermediate coating comprises plasma spray coating.

6. The showerhead of claim 1, wherein the advanced coating comprises Yttrium.

7. The showerhead of claim 1, wherein the coating formed on the surface of the perforated gas plate is the multi-layered coatings.

8. A method for fabricating a coating over at least a partial surface of a showerhead for a plasma chamber, the showerhead having a surface configured for facing and being exposed to the plasma during processing in the plasma chamber, the method comprising:
fabricating a showerhead with a perforated gas plate having multiple gas injection holes at the bottom surface;
inserting the showerhead into a vacuum chamber in an orientation such that the surface faces a source material positioned within the vacuum chamber;
evaporating or sputtering the source material inside the vacuum chamber;
injecting gas containing reactive species and non-reactive species into the vacuum chamber; and
igniting and maintaining plasma in front of the showerhead surface such that ions of the ionized reactive species and ionized non-reactive species impinge upon the showerhead surface and chemically interact with source materials to thereby form a coating over at least a partial surface of the showerhead;
wherein the coating comprises atoms from the source material and atoms from the reactive species.

9. The method of claim 8, further comprising roughening the surface of the showerhead prior to inserting the showerhead into the vacuum chamber to achieve surface roughness above 4 um.

10. The method of claim 8, wherein the source material comprises Yttrium.

11. The method of claim 10, wherein the non-reactive species comprises argon and the reactive species comprises one of oxygen and fluorine.

12. The method of claim 8, further comprising applying negative bias to the showerhead while maintaining the plasma inside the vacuum chamber.

13. The method of claim 8, further comprising applying an intermediate coating to the showerhead surface prior to inserting the showerhead into the vacuum chamber, wherein the intermediate coating has surface roughness above 4 um.

14. The showerhead of claim 13, wherein the intermediate coating comprises anodized layer.

15. The method of claim 13, wherein applying the intermediate coating comprises applying plasma spray coating.

16. The method of claim 8, wherein the coating formed on the surface of the showerhead is the multi-layered coatings.

17. A method for forming a coating over at least a partial surface of a showerhead for a plasma chamber, the showerhead having a surface configured for facing and being exposed to the plasma during processing in the plasma chamber, the method comprising:
inserting the showerhead into a vacuum chamber in an orientation such that the surface faces a source material positioned within the vacuum chamber;
applying potential bias to the showerhead;
effecting a physical process to vapor of the source material to condense on the showerhead surface; and
effecting a chemical process to cause active species to react with the condensed source material to thereby form a coating over the showerhead surface;
wherein the coating having a dense structure with random crystal orientation and with a porosity less than 3% and a surface roughness above 1 um.

18. The method of claim 17, further comprising roughening the showerhead prior to inserting the showerhead into the vacuum chamber to achieve a surface roughness above 4 um.

19. The method of claim 17, wherein the source material comprises Yttrium.

20. The method of claim 17, wherein the coating formed on the showerhead surface is the multi-layered coatings.
